(19) United States
(12) Patent Application Publication
(10) Pub. No.: US 2005/0289247 A1
(43) Pub. Date: Dec. 29, 2005

(54) Interactive system using electronic tags

(75) Inventors: Paul R. Simons, Redhill (GB); David P. Walker, Redhill (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V.

(21) Appl. No.: 10/520,213

(22) PCT Filed: Jun. 25, 2003
(86) PCT No.: PCT/IB03/02881

§ 371 Date: Jan. 3, 2005

(30) Foreign Application Priority Data
Jul. 5, 2002 (GB) 0215535.6

(51) Int. Cl. G06F 3/00

(52) U.S. Cl. 710/4

(57) ABSTRACT

An interactive system which makes use of interactive electronic tags (ID) includes a tag reader (24) and a processing terminal (32). Profile information stored on an interactive tag (ID) can be altered using profile data, which may be promotional data, carried by another tag (PRINF) in accordance with operating instructions, for example cut, copy, paste, delete and so on, carried by a further tag (ACT), when said interactive, another and further tags are read in conjunction by the tag reader (24).

The present invention relates to an interactive system using electronic interactive tags.

There are two types of electronic interactive tags, active and passive. Active tags carry their own power supply in the form of a physically small, low leakage battery. Such tags are usually of a transponder type which respond to an interrogating, low power radio signal by generating a response signal either at the same or different frequency, for example a sub-multiple of the interrogating frequency, and optionally encoded, depending on the application. Passive tags, that is tags which do not carry a battery, are in widespread use in the detection of stolen goods from retailers and tracking of goods in transit. Such simple tags are bound into packaging of products and can be detected when they pass through specially designed gates at the exit to shops, warehouses, stores and the like. In the case of a tag being attached to an article to be sold, the tag is removed at the point of sale and the purchaser can proceed uninterrupted through the exit.

More sophisticated tags are in use which carry unique serial numbers on packages in much the same way as barcodes but have the advantage that they are not as sensitive to the orientation of the label. The range in which the tags can be detected depends on the type of tag but can range from a few centimetres to about a metre. The serial numbers allow packages to hold a unique identification which provides a wide range of applications for tags ranging from the tracking and logistics involved in the distribution of goods to the routing of airport baggage.

Currently used tags frequently have unused programmable data space, typically about 100 to 3000 bytes, within the device which is available for storing additional data. For example, a person may wish to subscribe to a particular service, request a favourite meal or indicate that a person is shopping and is open to SMS (Short Message Service) discounts on goods, such as clothing. A problem with programming tags is that it requires specialist hardware and software that is not available consumer. Consequently this mitigates against the wider use of tags and their applications.

An object of the present invention is to facilitate the programming of tags.

According to a first aspect of the present invention there is provided a method of updating a user profile in an interactive system, comprising combining the information contained on an identifier tag and at least one interchangeable profile data tag.

According to a second aspect of the present invention there is provided a method of updating information in a memory field of an interactive tag, comprising accessing the memory field of the interactive tag, determining from a second tag data to be used to update the said profile information and updating the profile information in accordance with an operating instruction contained in a third tag.

According to a third aspect of the present invention there is provided an interactive system comprising tag reading means, an interactive tag having a store for personal identifier information and a programmable space for storing profile information, a second tag carrying profile data and a third tag carrying an operating instruction, and means responsive to reading the interactive, second and third tags in conjunction for using the profile data and the profile information in accordance with the operating instruction.

According to a fourth aspect of the present invention there is provided a method of promoting a product/service, comprising a promoter supplying profile tags having promotional data stored thereon for issue with an article, a user having an interactive tag with programmable storage space thereon using the promotional data to alter the content of the programmable storage space in accordance with operational instructions carried on an action tag read in conjunction with the profile and interactive tags, wherein the relevant product/service suppliers remunerate the promoter.

According to a fifth aspect of the present invention there is provided an interactive tag comprising storage means having stored therein identity information and profile information which conditions a tag reader.

According to a sixth aspect of the present invention there is provided an interactive tag having stored profile data which can be altered as desired in accordance with operating instructions carried by another tag when read in conjunction with the interactive tag.

According to a seventh aspect of the present invention there is provided an interactive tag having stored profile information which can be operated on by profile data carried by another tag in accordance with operating instructions carried by a further tag, when said interactive, another and further tags are read in conjunction.

The present invention will now be described, by way of example, with reference to the accompanying drawings, wherein:

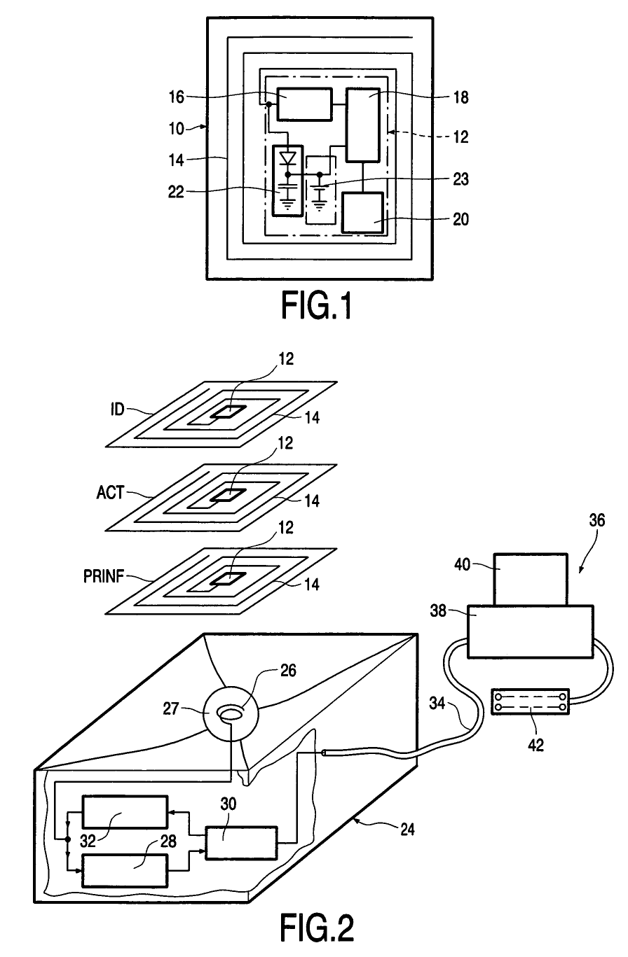

FIG. 1 is a sketch of a passive tag, and

FIG. 2 is a sketch of a tag reader with part of its casing broken away together with some different types of tags.

In the drawings the same reference numerals have been used to indicate corresponding features.

Referring to FIG. 1, the illustrated passive tag 10 comprises an integrated circuit (or chip) 12 which is coupled to a spiral coil antenna 14. The chip 12, which may be fabricated using CMOS technology, comprises a radio transceiver 16 which coupled to a processing stage 18. A power supply stage 22 is coupled to the antenna 14 for deriving current to energise the chip 12 from RF power received inductively by way of a tag reader 24 (FIG. 2). The stage 22 includes rectifying means for deriving current from the inductively supplied power and supplies it to the processor 18 which distributes to other stages in the chip 12.

Optionally the tag 10 may be an active tag, that is, a tag whose circuitry is powered by an integrated battery 23 which replaces the power supply stage 22.

In the case of what will be termed an interactive (or identifier) tag, which may be an active tag rather than a passive tag, the RAM 20, which has a storage space of the order of 100 to 3000 bytes, typically stores the user's identity and contact details. This information only occupies a portion of the programmable available in the RAM. The remaining data space can be used for other purposes such as the user's profile or URL.

Programming the remaining data space has normally been done using specialist hardware and software which is not generally available to the average consumer. The method in accordance with the present invention makes use of conjointly read tags of different types to effect programming of the data space remaining on the identifier tag.

Referring to FIG. 2, a tag reader 24 comprises an inductive transducer 26 such as an antenna in the form of a coil located under a protective cover 27 in the centre of a shallow concave dish. The transducer 26 is coupled to a module comprising a receiver and demodulator 28 having an output coupled to a micro-controller 30. An RF amplifier 32 constituting a transmitter is coupled between an output of the micro-controller 30 and the transducer 26. The transmitter may operate at any suitable frequency, for example 13.56 MHz. The micro-controller 30 controls the modulation of the 13.56 MHz signal and processes data derived by the demodulator 28. The micro-controller is coupled by a data link 34 to a processing apparatus 36 which may be a personal computer 38 having a VDU 40 and a keyboard 42 or a dedicated unit having a VDU 40. The data link 34 comprises, or is similar in function to, a USB connector which is able to carry power and two-way data.

The micro-controller 30 generates a logic signal for the time and length of modulation and the 13.56 MHz carrier is modulated with this logic signal to transmit data from the processing apparatus to the relevant tag.

Data may transmitted to a tag as a 1 out of 256 Pulse Position Code or by some other suitable technique. Power is transferred to the tag using the principle of a loose coupled transformer whereby the antenna coil 26 generates a magnetic field. Some of the magnet flux flows through the tag antenna which is in close proximity to the antenna coil 26 and induces a voltage therein. The voltage drives a current and the tag will start operating.

In the opposite direction data may be transmitted from the tag as a Manchester coded subcarrier with a frequency of 423.75 kHz. The method used may be “load modulation” in which the tag continuously changes the load on the magnetic field according to the information to be transmitted. Weakening the magnetic field is detected by the receiver 28.

In order to effect programming of the unused data space in the RAM 20 (FIG. 1) of an interactive tag ID which may contain profile information which may be altered, one or more tags of different types is or are used in conjunction with the interactive tag ID by simply placing them on the cover 27 over the transducer 26 of the tag reader 24. The information carried by each type of tag is read by the tag reader 24 and relayed to the processing. apparatus 32 which initiates updating the profile information stored in the RAM 20 (FIG. 1) of the interactive tag ID. The other types of tags include a profile information tag PRINF and an action tag ACT. The architecture of the different types of tags is similar that shown in FIG. 1 in that they comprise a chip 12 and a spiral coil 14.

The action tag ACT, which is likely to be a passive tag, contains specific operating commands which when read by the card reader 24 can be used to carry out any one of a range of operations such as add, subtract, multiply, divide, cut, copy, paste, delete, protect or unprotect information stored on an interactive tag ID. Additionally the action tag ACT has the ability to control what information is released by an identifier tag, viz. let everything through, only profile or only high priority.

The profile information tag PRINF, which is likely to be a passive tag, holds information that is designed to be transferred to, or be involved in an operation on the data stored on, the interactive tag ID depending on the operating command read-out from the action tag ACT. The information could be a sum of money or a URL. There is only one instance of this information on the profile information tag PRINF and once it has been copied, the information actually copied is protected or deleted to prevent recopying. The data can be copied to an interactive tag ID, or copied by a tag reader, for example used in the payment of a transaction. In all cases the information taken is removed from the profile information tag PRINF. Another class of profile information tags contain access to specific services, subscription or membership. They are designed only to be used in conjunction with another tag. Under some circumstances they may be destroyed or copy protected when information has been copied to an interactive tag ID.

When information is transferred to the interactive tag, it is retained on this tag until it is overwritten or erased.

In a variant of the embodiment described with reference to FIG. 2, the tags may not actually be placed in a tag reader but be read simultaneously when they come in close range of a tag reader which may be implemented as a booth having a tag reader therein, the tags being carried on the person of the user. Confirmation of the co-existence of the tags as a group rather than a random coincidence of non-associated tags may be obtained by the tags moving out of range simultaneously. This may be used to trigger the combining of the meanings to the tag reading system.

An example of a possible application of the use of profile information tag PRINF is stimulating interested people's interest in what golfing products and services are available when visiting a large shopping mall. In order to do this a promoter makes available to the publisher of a golfing magazine a supply of PRINF tags having “Golf” as the profile information. The PRINF tag, which is a discardable read once only tag, is removed from the magazine by the user and using the method in accordance with the present invention has his personal profile on his interactive tag ID, which may be an active tag, updated to include 2golf” as a topic of interest. As the user wanders around the shopping mall, his profile is read by tag readers at the entrances of shops and if there is anything of interest to a golfer, such as equipment, clothing, shoes, books and magazines, this is drawn to the user's attention and a sale may result.

In order to finance this promotion, the promoter makes a charge to the various shops and product suppliers.

In a refinement, the PRINF tag may be a means whereby a user of an interactive tag can earn discounts. For example say a golfing magazine carries a profile information tag PRINF having the message “Golfers receive huge discounts over SMS (Short Message Service) when visiting the XYZ shopping mall”. A consumer having a cellular telephone may use this tag in two ways. Firstly, to associate this message with the profile information on his interactive tag by taking his own interactive tag, an action tag containing the operational instruction to “add” or “combine” and the profile information tag to a tag reader which will detect them simultaneously causing the SMS service to be initiated. Secondly, to take this action beforehand by adding the message to the profile information in the dynamic space on the user's interactive tag and subsequently discarding the profile information tag PRINF

In both cases the tag information may be detected at a shop doorway in the shopping mall, allowing the person's phone number, which is part of the user information stored on the inactive tag, to be read together with the discount information causing the SMS service to be initiated. This could result in a SMS message being sent offering a sales discount at the store which the. person has just entered thereby increasing the chance of a sale.

The promoter can gauge the effectiveness of this type of discounted price sales promotion from the shops' records. Armed with this information the promoter can negotiate his terms of business not only with the vendors but also with the magazine publisher (or any other supplier of goods which can be used to circulate PRINF tags).

In this illustration as well as other examples the co-location of the action tag ACT with the interactive tag ID and the profile information tag PFINF has brought about an updating of the information in the RAM of the interactive tag by a tag reader.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of interactive systems employing co-located tags and component parts therefor and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of updating a user profile in an interactive system, comprising combining the information contained on an identifier tag and at least one interchangeable profile data tag.

2. A method as claimed in claim 1, characterised in that the information contained on the profile data tag is copied onto the identifier tag.

3. A method of updating information in a memory field of an interactive tag, comprising accessing the memory field of the interactive tag, determining from a second tag data to be used to update the said profile information and updating the profile information in accordance with an operating instruction contained in a third tag.

4. A method as claimed in claim 3, characterised in that the second and third tags are read in conjunction with the interactive tag.

5. A method as claimed in claim 3, characterised by submitting the interactive, second and third tags substantially simultaneously to a reading station.

6. A method as claimed in claim 5, characterised by updating the profile information as the tags are removed from the reading station.

7. An interactive system comprising tag reading means, an interactive tag having a store for personal identifier information and a programmable space for storing profile information, a second tag carrying profile data and a third tag carrying an operating instruction, and means responsive to reading the interactive, second and third tags in conjunction for using the profile data and the profile information in accordance with the operating instruction.

8. A system as claimed in claim 7, characterised in that the tag reading means has RF coupling means and in that each of the interactive, second and third have coils for use with the RF coupling means.

9. Apparatus as claimed in claim 8, characterised in that at least the second and third tags are passive tags and in that they are powered by way of the RF coupling means.

10. An interactive tag comprising storage means having stored therein identity information and profile information which conditions a tag reader.

11. An interactive tag having stored profile data which can be altered as desired in accordance with operating instructions carried by another tag when read in conjunction with the interactive tag.

12. An interactive tag having stored profile information which can be operated on by profile data carried by another tag in accordance with operating instructions carried by a further tag, when said interactive, another and further tags are read in conjunction.

13. A method of promoting a product/service, comprising a promoter supplying profile tags having promotional data stored thereon for issue with an article, a user having an interactive tag with programmable storage space thereon using the promotional data to alter the content of the programmable storage space in accordance with operational instructions carried on an action tag read in conjunction with the profile and interactive tags, wherein relevant product/service suppliers remunerate the promoter.

14. A method as claimed in claim 13, characterised in that the profile tags are read once only tags.
